(19) United States
(12) Patent Application Publication
(10) Pub. No.: US 2013/0204867 A1
(43) Pub. Date: Aug. 8, 2013

(54) Selection of Main Content in Web Pages

(71) Applicants: Suk Hwan Lim, Palo Alto, CA (US); Li-Wei Zheng, Beijing (CN); Jian-Ming Jin, Beijing (CN); Hui-Man Hou, Beijing (CN)

(72) Inventors: Suk Hwan Lim, Palo Alto, CA (US); Li-Wei Zheng, Beijing (CN); Jian-Ming Jin, Beijing (CN); Hui-Man Hou, Beijing (CN)

(73) Assignee: HEWLETT-PACKARD DEVELOPMENT COMPANY, LP., Houston, TX (US)

(21) Appl. No.: 13/812,434

(22) PCT Filed: Jul. 30, 2010
(86) PCT No.: PCT/CN2010/001157

§ 371 Date: Mar. 25, 2013

(51) Int. Cl. G06F 17/30

(52) U.S. Cl. CPC G06F 17/3053
USPC 707/723

(57) ABSTRACT

A system and method for selecting main content (350) from web pages includes receiving a web page (205) by a web page analysis device (105) and scoring sub-trees (209) within the web page (205). The single sub-tree (225) with the highest final score is selected as the main content (350) of the webpage (205).

### BACKGROUND

Web pages provide an inexpensive and convenient way to make information available to its consumers. However, as the inclusion of multimedia content, embedded advertising, and online services becomes increasingly more prevalent in modern web pages, the web pages themselves have become substantially more complex. For example, in addition to their main content, many web pages display auxiliary content such as background imagery, advertisements, or navigation menus, and links to additional content.

It is often the case that owners or consumers of web pages wish to utilize or adapt only a portion of the information presented in a web page. Such uses of only a portion of the content presented in a web page can require tedious effort on the part of a user to distinguish among the different types of content on the web page and retrieve only the desired content. Automatic selection of the main content in web pages can eliminate extraneous or undesired content and significantly streamline a number of workflows. For instance, a user may desire to print a physical copy of an internet article without reproducing any of the irrelevant content on the web page containing the article. Similarly, an owner of a web page may wish to adapt a web page into another document, such as a marketing brochure, without including content in the web page that is superfluous to the new document. Additionally, a user may wish to display only the most relevant web content on a computing device with a limited screen size. Other applications which may benefit from automatic selection of the main content in web pages include: search, information retrieval, information management, archiving, and other applications.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a diagram of an illustrative system for selection of main content in a web page, according to one example of principles described herein.

FIG. 2A is a Document Object Model (DOM) tree for an illustrative web page, according to one example of principles described herein.

FIG. 2B is a layout of an illustrative web page which corresponds to the DOM tree of FIG. 2A, according to one example of principles described herein.

FIG. 2C is diagram of an illustrative web page showing the main content of the web page, according to one example of principles described herein.

FIG. 3 is a flowchart of an illustrative content selection algorithm, according to one example of principles described herein.

Throughout the drawings, identical reference numbers designate similar, but not necessarily identical, elements.

### DETAILED DESCRIPTION

The present specification discloses various methods, systems, and devices for automatically selecting the main part of a web page. As discussed above, there are many applications where automatically selecting the main pail of a web page can be advantageous. For purposes of explanation, the specification uses the illustrative example of selecting the main part of a web page to enhance the printing of the web page. Currently, when a web page is printed, it includes a variety of contents. For example, in addition to the main content, many web pages display content such as background imagery, advertisements, or navigation menus, headers/footers, and links to additional content. Some of the contents may be printworthy, but the user may not want to print some or all of the auxiliary contents. Ideally, the algorithm automatically selects only the main content and presents it to the user for printing.

There are a number of challenges in automatic selection of main content in web pages. For example, web pages vary widely by content type. Common types of web pages include: news, shopping, blog, map, and recipe web pages. The web page layouts also vary widely across the different types of web pages. The web pages also included a variety of content, including text, images, video and flash. To effectively select the main content in web pages, the algorithm determines not only a relative ordering of importance of content but also an absolute determination whether content can be categorized as main content. According to one illustrative example, the algorithm determines block, area, or areas of the web page which contains the main content.

As used in the present specification and in the appended claims, the term “web page” refers to a document that can be retrieved from a server over a network connection and viewed in a web browser application.

As used in the present specification and in the appended claims, the term “segment” refers to one of a plurality of coherent units into which the entire content of a web page has been partitioned.

As used in the present specification and in the appended claims, the term “coherent,” as applied to a segment, refers to the characteristic of having content with the same type or property.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

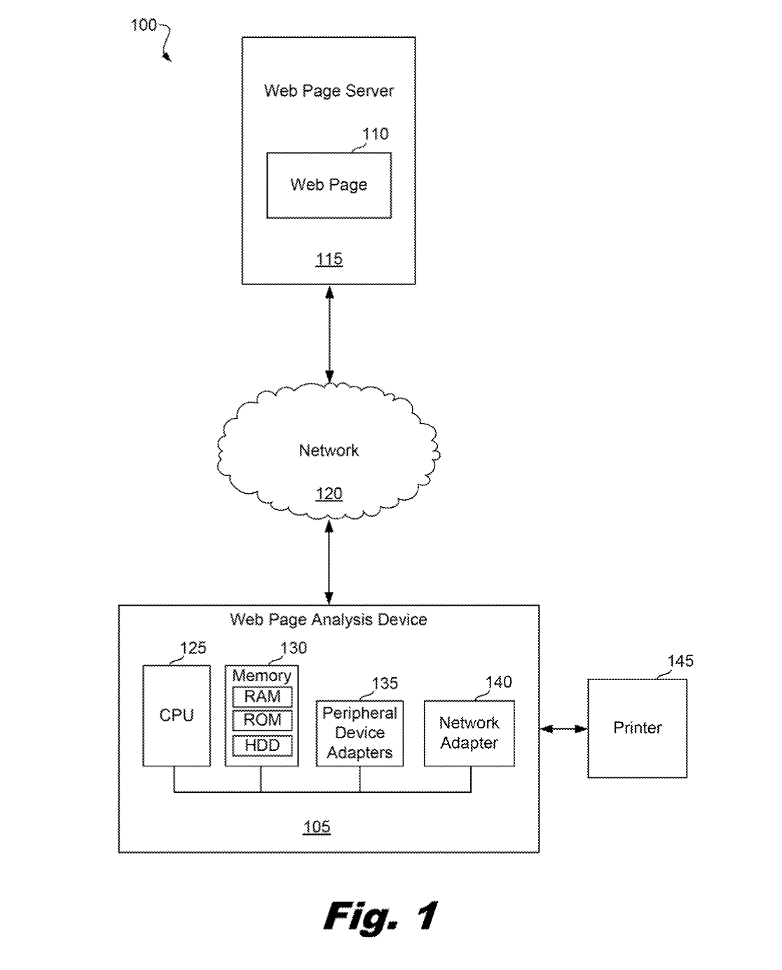

Referring now to FIG. 1, an illustrative system (100) for automatic selection of the main content in web pages includes a web page analysis device (105) that has access to a web page (110) stored by a web page server (115). In the present example, for the purposes of simplicity in illustration, the web page analysis device (105) and the web page server (115) are separate computing devices communicatively coupled to each other through a mutual connection to a network (120). However, the principles set forth in the present specification extend equally to any alternative configuration in which a web page analysis device (105) has complete access to a web page (110). As such, alternative examples within the scope of the principles of the present specification include, but are not limited to, examples in which the web page analysis device (105) and the web page server (115) are implemented by the same computing device, examples in which the functionality of the web page analysis device (105) is implemented by multiple interconnected computers (e.g., a server in a data center and a user's client machine), examples in which the web page segmentation device (105) and the web page server (115) communicate directly through a bus without intermediary network devices, and examples in which the web page analysis device (105) has a stored local copy of the web page (110) which is to be analyzed to automatically select its main content.

The web page analysis device (105) of the present example is a computing device configured to retrieve the web page (110) hosted by the web page server (115) and divide the web page (110) into multiple coherent, functional blocks. In the present example, this is accomplished by the web page analysis device (105) requesting the web page (110) from the web page server (115) over the network (120) using the appropriate network protocol (e.g., Internet Protocol (“IP”)). Illustrative processes for automatic selection of the main content in web pages are set forth in more detail below.

To achieve its desired functionality, the web page analysis device (105) includes various hardware components. Among these hardware components may be at least one processing unit (125), at least one memory unit (130), peripheral device adapters (135), and a network adapter (140). These hardware components may be interconnected through the use of on more busses and/or network connections.

The processing unit (125) may include the hardware architecture necessary to retrieve executable code from the memory unit (130) and execute the executable code. The executable code may, when executed by the processing unit (125), cause the processing unit (125) to implement at least the functionality of retrieving the web page (110) and analyze a web page (110) for automatic selection of its main content according to the methods of the present specification described below. In the course of executing code, the processing unit (125) may receive input from and provide output to one or more of the remaining hardware units.

The memory unit (130) may be configured to digitally store data consumed and produced by the processing unit (125). The memory unit (130) may include various types of memory modules, including volatile and nonvolatile memory. For example, the memory unit (130) of the present example includes Random Access Memory (RAM), Read Only Memory (ROM), and Hard Disk Drive (HDD) memory. Many other types of memory are available in the art, and the present specification contemplates the use of any type(s) of memory in the memory unit (130) as may suit a particular application of the principles described herein, in certain examples, different types of memory in the memory unit (130) may be used for different data storage needs. For example, in certain examples the processing unit (125) may boot from ROM, maintain nonvolatile storage in the HDD memory, and execute program code stored in RAM.

The hardware adapters (135, 140) in the web page analysis device (105) are configured to enable the processing unit (125) to interface with various other hardware elements, external and internal to the web page analysis device (105). For example, peripheral device adapters (135) may provide an interface to input/output devices to create a user interface and/or access external sources of memory storage Peripheral device adapters (135) may also create an interface between the processing unit (125) and a printer (145) or other media output device. For example, in examples where the web page analysis device (105) is configured to generate a document based on functional blocks extracted from the web page's content, the web page analysis device (105) may be further configured to instruct the printer (145) to create one or more physical copies of the document.

A network adapter (140) may provide an interface to the network (120), thereby enabling the transmission of data to and receipt of data from other devices on the network (120), including the web page server (115).

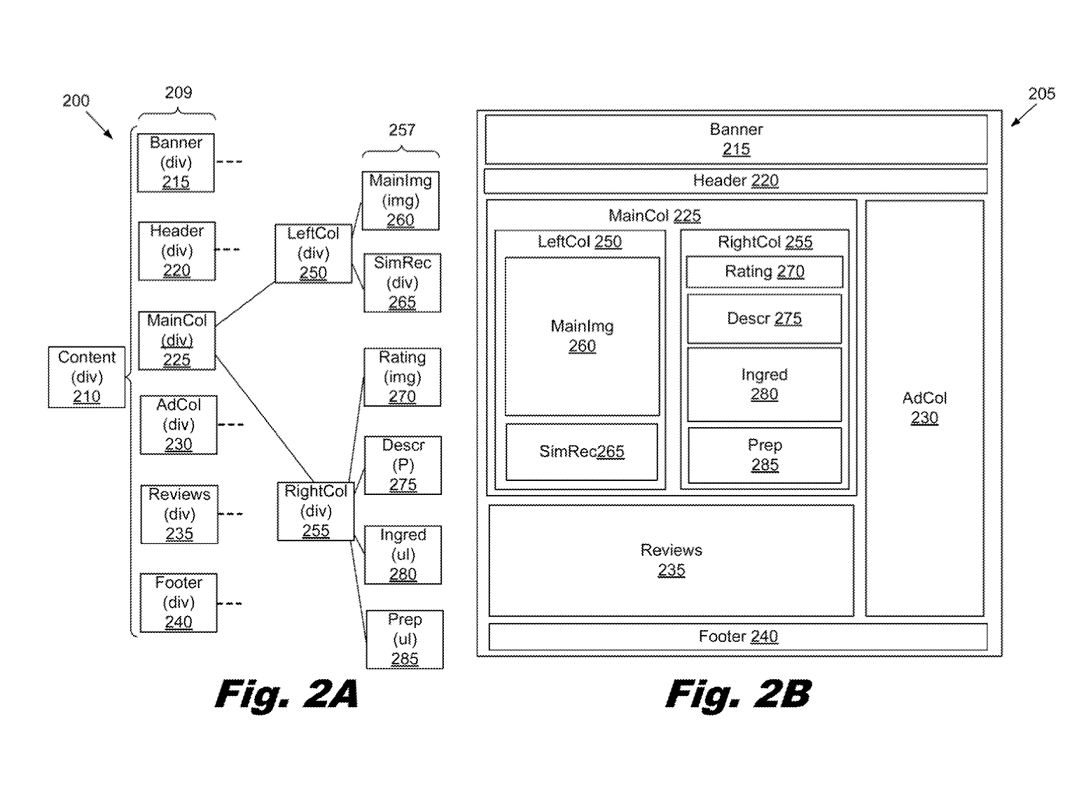

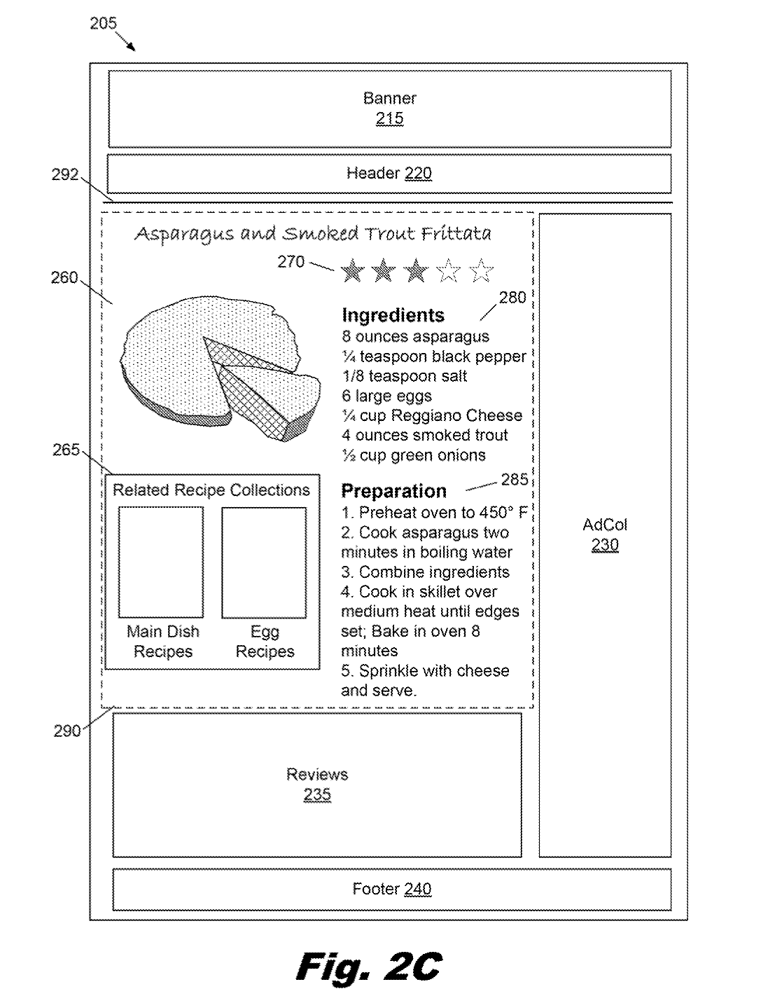

FIGS. 2A-2C are illustrative diagrams which illustrate the Document Object Model (DOM) tree, layout, and visual elements in a web page. In this example, the web page is from a recipe website and includes an image of the dish which is described, a rating of the dish by users, ingredients to make the dish, preparation instructions, and other elements.

FIG. 2A shows an illustrative DOM tree (200) which shows the hierarchy of DOM elements in the web page. DOM is a cross-platform and language independent convention for representing and interacting with web page elements in HyperText Markup Language (HTML), eXensible HyperText Markup Language (XHTML) and eXensible Markup Language (XML). In FIG. 2A, each of the elements in the DOM tree is labeled with a name and a tag. For example, the banner element (215) is named “Banner” and a tag “div”. The DOM tag “div” indicates that styles in this element are defined in Cascading Style Sheets (CSS) language. Additionally, the DOM tag “img” indicates the presence of an image; a “p” tag indicates a paragraph; and the “ui” tag indicates a list.

The root element in this DOM tree is the Content element (210) which has six sub-trees (209): Banner (215); Header (220); MainCol (225); Adcol (230); Reviews (235); and Footer (240). For purposes of illustration, subelements (250-285) are shown for only for the MainCol sub-tree (225). Dashed lines extending to the right of the other sub-trees show the continuation of the sub-trees with elements which are not illustrated in FIG. 2A.

The MainCol sub-tree (225) has two elements, LeftCol (250) and RightCol (255), at the next hierarchal level. LeftCol (250) has two elements at the lowest hierarchal level (257): MainImg (260) and SimRec (265). The RightCol (255) has four elements at the lowest hierarchal level (257): Rating (270), Descr (275), Ingred (280), and Prep (285). The elements at the lowest hierarchal level (257) are also called leaf nodes.

FIG. 2B shows regions in a web page (205) which correspond to the various elements in the DOM tree (200, FIG. 2A). The Banner (215) and AdCol (230) elements reserve locations in the web page (205) for a banner ad and other advertisements. The Header (220) may contain a number of elements including navigation tabs, search fields and other sub-elements. Similarly, the Footer (240) may contain a number elements including links to related sites, terms of use and privacy policies, copyright notices, and other elements. The Reviews sub-tree (235) may contain ratings and comments from various users of the site who have tried the recipe.

In this example, the MainCol (225) sub-tree contains the “main content” which a user would typically print or archive for further reference. The MainCol (225) contains a left column (250) and a right column (255). In left column (250), an image of the dish is shown in the MainImg element (260). Similar recipes are shown below the image in the SimRec element (265). The right column (255) includes an overall rating for the dish (270), a description of the dish (275), ingredients of the dish (280), and preparation instructions (285). These elements (260-285) may have a number of additional subelements.

FIG. 2C shows the web page (205) with the visible content of the MainCol (225, FIG. 2B) sub-tree shown in more detail. The content has been simplified for purposes of illustration. There may be a variety of nonvisual code and/or elements present in the MainCol (225, FIG. 2B). However, this nonvisual information is not helpful to the user when the recipe is printed. Consequently, during the analysis of the web page to determine the main content of the web page, non-visual information is not weighted heavily or may not be considered at all. As discussed above, when printing or archiving, the user is typically interested in preserving, printing or copying the main content of the page. Banner ads, page navigation, reviews, and links typically contain information which is not directly relevant to the user's interest in the page and are not directly related to the content the user wishes to preserve. As used in the specification and appended claims, the term “main content” refers to visual web page content which a user would typically like to preserve, print, or copy for future reference. In general, the main content of the essence of the web page and may include text, pictures, icons, or other information.

The main content (290) is shown as a dashed box around a number of elements including the MainImg element (260), SimRec element (265), overall rating for the dish (270), ingredients of the dish (280), and preparation instructions (285). Not included in the main content are the Banner (215), Header (220), AdCol (230), Reviews (235) and Footer (240). A visual separator (292) divides the header (220) from the main content (290).

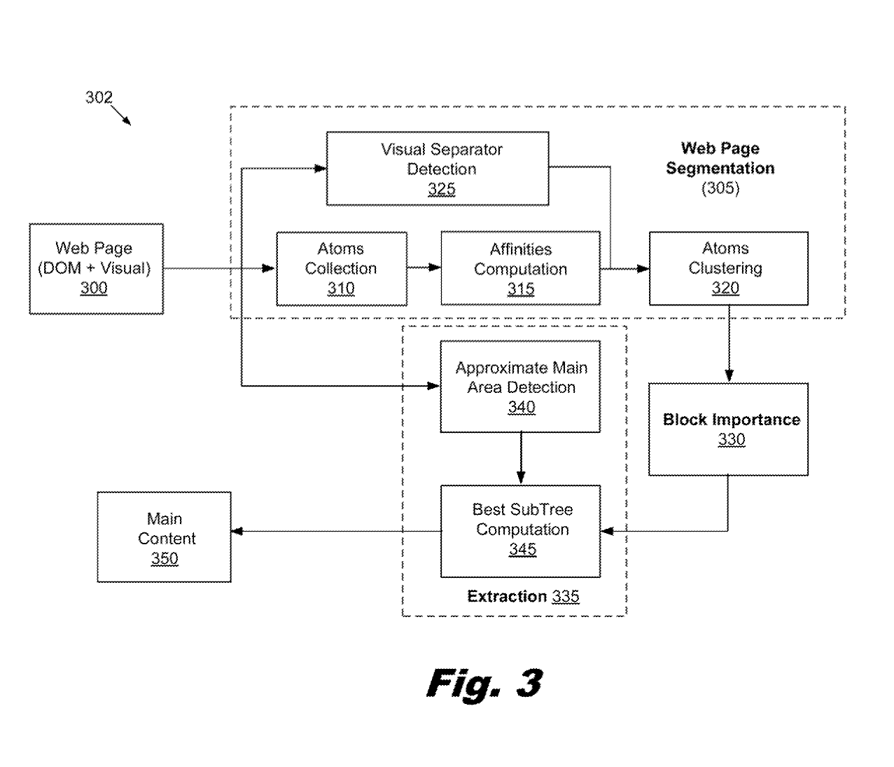

FIG. 3 is diagram which shows a content selection algorithm (302) and work flow between its various components. At a high level, the web page analysis device (105, FIG. 1) accepts an input web page (300) and returns the main print content (350). According to one example, the web browser or its rendering engine parses and renders the input web page (300) to generate the DOM tree (200, FIG. 2A) with the associated visual information such as the spatial coordinates of the nodes and rendered images. This DOM information, together with the visual data, is fed into the work flow at several different locations.

Selecting the print-worthy content area can be largely divided into three steps. The first step is the web page segmentation (305) which divides the web page into several coherent areas. The second step is the block importance computation (330) which calculates the importance score for each block or area. The third step is the extraction (335) which outputs the most print-worthy area given the segmentation and the block importance results. Details for each step are described in the following subsections.

### Web Page Segmentation

The web page segmentation (305) divides the web page into coherent areas where each area has a meaningful function in the document. Examples of meaningful function include but are not limited to title and header. In general, the web page segmentation (305) uses a bottom-up approach. To do this, the web page is first divided into many basic elements called atoms. The atoms collection module (310) divides the web page into many basic elements called atoms. The atoms are basic elements of the web page which generally cannot be broken up into smaller pieces. The atom generation is collectively exhaustive because it includes all useful contents and mutually exclusive because there is no spatial overlap between atomic elements.

According to one illustrative example, the atoms can be thought of as leaf nodes in the DOM tree (200, FIG. 2A). However, this analogy should be refined to satisfy the collectively exhaustive and mutually exclusive properties. For example, since most of the spatial overlaps between the elements occur when one or more of them are invisible, the invisible elements are filtered out. The invisible elements are identified in one or more ways: by examining the visibility or the display attribute; determining whether the elements are within the bounds of the web page; and jointly examining the overflow attribute and the spatial coordinates. Optionally, nodes with certain tags such as <style>, <script>, <base>, <meta>, <area>, <noscript> and <option> are filtered out as they are not useful for web printing.

In summary, the atoms collection module (310) gathers all the visible and useful leaf nodes by crawling the DOM tree (200, FIG. 2A) and examining its attributes. Filtering out contents that are not visible or useful for printing improves the robustness of subsequent analysis steps. However, the atoms collection module (310) is configured such that it does not filter out useful content and violate the collectively exhaustive property.

The affinities between the atoms are then calculated by the affinities computation module (315). The affinities (or distances) are computed between all the atoms collected by the atoms collection module (310). The underlying idea is to measure how “similar” the two atoms are in many different ways and then judge how likely it is for the two atoms to be merged or belong to one area/block. By using a wide variety of characteristics/dimensions to calculate affinities, the affinities computation becomes more robust and accurate.

According to one illustrative example, there are tens of affinity dimensions. For example, there may be 60 or more affinity dimensions used by some affinity computations modules (315). Each of the affinity dimensions may be classified into the following categories: i) geometric, ii) DOM structure, iii) tag type and iv) style. One example of geometric affinity is the Euclidean distance between the spatial locations of the two atoms. The larger this distance is, the less likely the two atoms are to be clustered together. Another example is horizontal/vertical overlap between atoms and whether they are aligned horizontally or vertically. One example of DOM structure affinity is the distance one needs to traverse in the DOM tree (200, FIG. 2A) to go from one atom to another. Another example is the difference in the order of initial DOM tree traversal. The affinity computation module (315) may also examine the HTML tag types (e.g. <IMG>, <P>) to determine whether the two atoms should be merged. Style such as font size, font style, font color and background color are also considered for affinities as well.

Visual separations in the web pages are detected by the visual separator detection module (325). The term “visual separations” refers to the division of web pages into multiple parts by lines or frames. We name such lines as visual separator lines. Frames are included in the visual separators as a frame is comprised of two horizontal lines and two vertical lines. Visual separator detection (325) computes the presence and the locations of visual separators in web pages. Such lines provide indications as to how the web page should be segmented. For example, an area needs to be divided further if a strong visual divider cuts across the area. We employ several methods to detect visual separators. First, elements with certain tags are identified as visual separators. Examples of such tags include <HR> and <TEXT AREA>. Second, HTML elements with border properties can be examined. These HTML elements are marked as visual separators if the corresponding borders are wider than zero. Third, a DOM node's background color may be different from its parent DOM node's background color. If their difference is bigger than a threshold, then the four borders of this DOM node are taken as visual separators. Fourth, the visual separator detection module (325) detects tiny images that have large repetitions since visual separators are often generated in such a way. The results from these and other methods can be appropriately merged to avoid lines detected multiple times. Once the visual separators are located, they are encoded into the affinity values between the atoms. If a visual separator is present between the atoms, then the affinity values between such atoms are very low, making them very difficult to be clustered into one segment.

The atoms are then clustered based on various affinity values by the atoms clustering module (320). Similar atoms are clustered into segments by examining their affinity values and selectively clustering the atoms with high affinities. The atom clustering module (320) uses a variety of information including the DOM and the visual representation of the page rather than relying only on a few aspects of the web page. While clustering can be performed by globally examining all the affinity values, a computationally simpler approach is to use composite affinities by performing various linear combinations affinity values where the weights are determined heuristically. In some examples, the weights, combinations, and other parameters can be obtained from a training data set.

The atoms are clustered into segments by merging the atoms whose affinities are above a certain threshold. Note that the threshold is not pre-determined but computed adaptively based on the input. The threshold is chosen such that a small increase in its value results in the largest decrease in the number of segments. Additionally or alternatively, additional constraints such as minimum and maximum bounds may limit the total number of segments. These thresholds can be selected to reflect the spatial characteristics of the web page design.

Web page segmentation is further described in PCT App. No. PCT/CN20101000523, entitled “Segmenting a Web Page into Coherent Functional Blocks,” to Suk Hwan Urn et al., filed Apr. 19, 2010, which is incorporated by herein by reference in its entirety.

### Block Importance

After the web page segmentation (305), the block importance score for each segment is computed by the block importance module (330). The importance of a segment is determined by many factors/features. The score of each feature is calculated and the scores are then combined using appropriate weighting values to obtain the final block importance score. These weights can be derived from a training data set or pre-defined by rules.

The following features are illustrative examples of features which can be used to calculate importance scores for the various segments in a web page.
Horizontal coverage is obtained by computing the horizontal extent of a segment over the total area of the page. The blocks covering near the horizontal center get higher scores.
Vertical coverage is obtained by computing the vertical extent of a segment over the total area of the page. The blocks covering near the top of the web page have higher scores.
Normalized text length is obtained by computing the text length of the segment over the maximal text length of all segments.
Link-to-text ratio is obtained by computing the link text length of the segment over the text length of the segment. Texts with higher density of anchor text are more likely to be a navigational bar or an advertisement.
Highlight text ratio is obtained by computing the highlight text length of the segment over the text length of the segment and then multiplying the highlight weight. For example, the weight of <H1> is larger than <H6>.
Normalized block area is obtained by computing the segment area over the maximal area of all segments.
Normalized number of child (DOM) nodes is obtained by computing the number of child nodes in the segment over the maximal number of child nodes in all segments.

### Extraction

Following the web page segmentation (305) and the block importance (330) calculation, the main content is selected based on the segmented blocks and their importance scores by the extraction module (335), in one example, the extraction algorithm (335) selects only a single sub-tree in the DOM tree of the original web page. This constraint is based on the observation that the main content area in most pages can be represented by one sub-tree. This additional constraint allows the extraction algorithm (335) to be more robust and stable.

As is shown in FIG. 3, there are two routes through which information enter the extraction module (335). A first route is through the block importance module (330) and a second route is through an approximate main area detection module (340). The second route through the approximate main area detection is an optional route. The approximate main area detection module (340) makes a preliminary and conservative estimate of which of the segments in the web page should be discarded. By making this preliminary estimate, the robustness of the overall system is improved and the computational time used to compute the main print content area (350) can be reduced.

Most web pages contain headers, footers or sidebars, which do not contribute to and are not part of the main content area. Consequently, the approximate main area detection (340) identifies and deletes these superfluous sub-trees from the DOM tree and other data to form a stripped-down web page. The stripped-down web page is a generous estimate of what portions of the web page may contain the main content area. This estimate is performed by computing features similar to those described above, but for the sub-trees instead of segments. Due to the mixture of content within a sub-tree (rather than the homogenous content for each segment), this method works well in determining the non-relevant content which should be filtered out of the web page.

The stripped-down web page and/or DOM tree is then passed to the best sub-tree computation module (345). In an alternative example, the entire web page is passed into the best sub-tree computation module (345) through the block importance module (330). The best sub-tree computation module (345) calculates the main content area (350). Where the stripped-down web page is used, all the remaining sub-trees in the stripped-down web page are considered as candidates for the main content node. Where the entire webpage is passed through the block importance module (330) to the best sub-tree computation module (345), all of the sub-trees in web page are considered as candidates. Final scores are computed for each candidate sub-tree. The final score for each sub-tree is calculated by multiplying the importance score of the sub-tree and its area score.

In order to compute the final importance score for the sub-tree, all the segments that spatially intersect with the sub-tree are found. Since each segment has a block importance score computed by the block importance module (330), the weighted average of the block importance scores can be calculated. The weights are proportional to the areas that intersect between the segments and the candidate sub-tree.

The area score is a function of the area or the size of the candidate sub-tree and reflects the prior knowledge of the desired size of the print-worthy content. This function can be modified to shape the behavior of main content selection. For example, the desired size of print-worthy content may be represented by a range of sizes, ratios of width to height, or other method. The desired size may be determined based on a number of factors, including the type of web page, printer settings, printer media sizes, user preferences, and other factors. The desired size of print-worthy content is used to penalize overly large or overly small candidate sub-trees whose selection would be detrimental to the user experience of web page printing.

The final score for each sub-tree is then calculated by combining the importance score and the area score for each candidate sub-tree. The candidate sub-tree with the highest score is then selected as the main content 350) for printing.

### Illustrative Example

To provide a concrete example, the content selection algorithm (302) shown in FIG. 3 will be applied to the simplified web page and DOM data shown in FIGS. 2A-2C. In this example, the user desires to print the main content (290. FIG. 2C) of the web page (205, FIG. 2C). To start the process, a web browser resident on the web page analysis device (105, FIG. 1) parses and renders the input web page (205, FIG. 2C) to generate the DOM tree (200, FIG. 2A) with the associated visual information such as the spatial coordinates of the nodes. This DOM tree (200, FIG. 2A), together with the visual data, is fed into the content selection algorithm (302) at several different locations. The web page analysis device (105, FIG. 1) accepts the input web page (205, FIG. 2C) and returns the main content area (350).

In a first step, the web page segmentation module (305, FIG. 3) divides the web page (205, FIG. 2C) into coherent areas where each area has a meaningful function in the document. To do this, the web page (205, FIG. 2C) is first divided into many basic elements called atoms by the atom collection module (310, FIG. 3). The atoms collection module (310) gathers all the visible and useful leaf nodes by crawling the DOM tree (200, FIG. 2A) and examining its attributes. For example, the leaf nodes (257. FIG. 2A) may be designated as atoms for the MainCol sub-tree (225). The other sub-trees (215, 220, 230, 235, 240, FIG. 2A) also have leaf nodes which are not shown in FIG. 2A. However, these sub-trees will also be analyzed to produce a group of atoms which are collectively exhaustive and mutually exclusive. During this atomization process, the atoms collection module (310, FIG. 3) may discard invisible elements since the invisible elements do not represent useful information for web printing. However, for archival or other data management purposes, the alternative approaches could be used.

The affinities between the atoms are then calculated by the affinities computation module (315, FIG. 3). As discussed above, the affinities (or distances) are computed between all the atoms collected by the atoms collection module (310, FIG. 3). For example, the affinities computation module (315, FIG. 3) may calculate the Euclidean distance between the spatial locations rating element (270, FIG. 2B) in the MainCol sub-tree (225, FIG. 2B) and all other atoms. The Euclidean distance between the rating element (270, FIG. 2B) and the description element (275, FIG. 2B) will be small, while the distance to atoms in the reviews sub-tree (235, FIG. 2B) will be larger. The larger this distance is, the less likely the two atoms are to be clustered together.

A variety of additional affinities can also be calculated. For example, the vertical or horizontal alignment of the atoms can be determined. The affinities computation module may analyze the atoms in the header (220, FIG. 2B) and determine that they are horizontally aligned. The affinities computation module (315, FIG. 3) may also determine that the Rating element (270, FIG. 2B), Descr element (275, FIG. 2B), Ingred element (280, FIG. 2B), and Prep element (285, FIG. 2B) are vertically aligned.

Additionally, the affinity computation module may determine that the Descr element (275, FIG. 2B) and the Ingred element (280, FIG. 2B) have the same font size, font style, font color and background color. These affinities further assist the web page analysis device (105, FIG. 1) in properly grouping the atoms in succeeding steps.

Visual separations in the web pages are detected by the visual separator detection module (325, FIG. 3). For example, the separator line (292, FIG. 2C) is identified as a visual separation which provides an indication that the atoms above the line are separate from the atoms below the line. The visual separator also determines from that the HTML description of the reviews element (235, FIG. 2C) produces a border which is wider than zero. This is also determined to be a visual separator. After identifying these and other visual separators within the web page (205, FIG. 2C), the visual separations are encoded into the affinity values between the atoms. If a visual separator is present between the atoms, then the affinity values between such atoms are very low, making them very difficult to be clustered into one segment.

The atoms are then clustered based on various affinity values by the atoms clustering module (320, FIG. 3). For example, the atoms clustering module (320, FIG. 3) determines that the Rating element (270, FIG. 2C), Descr element (275, FIG. 2C), Ingred element (280, FIG. 2C), and Prep element (285, FIG. 2C) should be clustered due to their proximity, absence of intervening visual separators, similarity in background color and font, and other affinities. The atoms clustering module (320, FIG. 3) makes similar determinations over the entire web page (205, FIG. 2B). When the calculated affinity values exceed an adaptively computed threshold, the atoms are grouped together to form segments.

After the web page segmentation (305, FIG. 3), the block importance score for each segment is computed by the block importance module (330, FIG. 3). In this example, the block importance module (330, FIG. 3) determines that banner sub-tree (215, FIG. 2B) has a low importance, the Reviews sub-tree (235. FIG. 2B) has a moderate importance, and the segment represented by the MainCol sub-tree (225, FIG. 2B) has a high importance. The high importance level of the MainCol sub-tree (225, FIG. 2B) is determined due to the large horizontal and vertical coverage of the MainCol sub-tree (225, FIG. 2B) with respect to the total area of the page. Further, the placement of the MainCol sub-tree (225, FIG. 2B) near the vertical and horizontal center of the page. The MainCol sub-tree (225, FIG. 2B) also contains a large portion of the text present in the web page (205, FIG. 2B). These and other factors contribute to the high importance assigned to the MainCol sub-tree (225, FIG. 2B).

Following the web page segmentation (305, FIG. 3) and the block importance (330, FIG. 3) calculations, the main content (350, FIG. 3) is selected based on the segmented blocks and their importance scores by the extraction module (335, FIG. 2B). In this example, the approximate main area detection module (340, FIG. 2B) makes a preliminary and conservative estimate of which of the segments in the web page should be discarded. This estimate is performed by computing features similar to those described above, except the computation is applied to features instead of segments. For example, the approximate main area detection module (340, FIG. 3) may calculate sizes and areas represented by each sub-tree. The approximate main area detection module (340, FIG. 3) then determines where each of the sub-trees are located within the overall webpage (205, FIG. 2C). As discussed above, headers (220, FIG. 2C) and footers (240, FIG. 2C) are routinely discarded. The approximate main area detection module (340, FIG. 3) may also examine the HTML content of the sub-trees to assist in determining which of the sub-trees should be discarded. For example, HTML content which has no text or points to external advertisement server for image retrieval could be indicative of an advertising area.

The approximate main area detection module (340, FIG. 3) determines that the Banner (215, FIG. 2B), Header (220, FIG. 2B), AdCol (230, FIG. 2B) and Footer (240, FIG. 2B) sub-trees should be discarded. This leaves only the Review sub-tree (235, FIG. 2B) and the MainCol sub-tree (225, FIG. 2B) for consideration as the main content area (350, FIG. 3). This portion of the web page (205, FIG. 2B) is a generous estimate of what portions of the web page may contain the main content area.

This stripped-down web page and DOM tree is then passed to the best sub-tree computation module (345, FIG. 3). In this step, the sub-tree that best represents the main content (350, FIG. 3) area is computed. In this example, the extraction algorithm/module (335, FIG. 3) selects only a single sub-tree in the DOM tree of the original web page (205, FIG. 2C). As discussed above, this additional constraint allows the extraction algorithm (335, FIG. 3) to be more robust and stable.

Scores are computed for the review sub-tree (235, FIG. 2B) and the MainCol sub-tree (225, FIG. 2B). These scores are calculated by multiplying the importance score of the sub-tree and its area score. The importance score is first computed based on all segments which are contained within or spatially intersect the sub-trees. For example, the importance score for the MainCol sub-tree (225, FIG. 28) includes contributions from segments represented by the LeftCol (250 FIG. 2B), RightCol (255 FIG. 2B), and their associated leaf nodes. These contributions have been previously calculated by the block importance module (330, FIG. 3). In this example, the importance score of the MainCol sub-tree (225, FIG. 2B) is significantly higher than the Reviews sub-tree (235. FIG. 2B). Similarly, in this example, the area importance of the MainCol sub-tree (225, FIG. 2B) is significantly higher than the Reviews sub-tree (235, FIG. 2B) because the MainCol sub-tree (225, FIG. 2B) is larger and more centrally located than the reviews sub-tree (235, FIG. 2B). Consequently, the MainCol sub-tree (225, FIG. 2B) is correctly chosen as the main content area (350 FIG. 3).

In sum, the content selection algorithm and system described above is effective in automatically selecting the main content from a wide variety of web pages. As discussed above, the selection of the main content of web pages can facilitate a number of workflows. For instance, a user may desire to print a physical copy of an internet article without reproducing any of the irrelevant content on the web page containing the article. In another example, the user may wish to scrape the main content from the web page to form a clip. The clip is then combined with other data to form a composite document. Other applications which may benefit from automatic selection of the main content in web pages include: search, information retrieval, information management, archiving, and other applications.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A method performed by a web page analysis device (105) comprising at least one processing unit (125) for selecting main content (350) from web pages comprising:
receiving, with the web page analysis device (105), a web page (205) by a web page analysis device (105);
scoring, with the web page analysis device (195), sub-trees (209) within the web page (205); and
selecting, with the web page analysis device (105), a single sub-tree (225) with the highest final score as the main content (350) of the webpage (205).

2. The method according to claim 1, further comprising detecting, with the web page analysis device (105), an approximate main area of the web page (205) using an approximate main area detection module (340) within the web page analysis device (105).

3. The method according to claim 2, in which detecting the approximate main area of a web page comprises analyzing DOM sub-trees (209) to produce a conservative determination of which sub-trees in the web page (205) should be discarded to produce a stripped-down web page containing at least one sub-tree.

4. The method according to claim 3, in which sub-trees (209) which are determined to be headers (220) and footers (240) are discarded to produce the stripped-down web page.

5. The method according to any of the above claims, in which scoring sub-trees (209) further comprises segmenting, with the web page analysis device (135), the web page (205) into coherent segments where each coherent segment has a meaningful function within the web page (205).

6. The method according to claim 5, in which scoring sub-trees (209) further comprises calculating a block importance for each of coherent segment of the web page (205).

7. The method according to any of the above claims, in which scoring sub-trees (209) comprises:
computing a sub-tree importance score;
computing an area score; and
combining the sub-tree importance score and area score to produce an final score.

8. The method according to claim 7, in which the sub-tree importance score is calculated by identifying all segments (260, 265, 270, 275, 280, 285) which intersect a sub-tree (225) and taking the weighted average of block importance scores of each segment which intersects the sub-tree (225).

9. The method according to claim 7, in which computing an area score comprises:
determining a desired size of print-worthy content; and
scoring candidate sub-trees (209) by penalizing sub-trees which are larger or smaller than the desired size of print-worthy content.

10. The method according to any of the above claims, further comprising outputting, with the web page analysis device (105), the main content (350) of the web page (205) for printing.

11. The method according to any of the above claims, further comprising scraping the main content (350) from the web page (205) to form a clip and combining the clip with other data to form a composite document.

12. A method performed by a with the web page analysis device (105) comprising at least one processing unit (125) of selecting main content from a web page for printing comprising:
receiving, with the web page analysis device (105), a web page (300) from a web page server (115);
parsing and rendering, with the web page analysis device (105), the web page (300) to generate a DOM tree (200) and visual information associated with the web page (300);
segmenting, with the web page analysis device (105), the web page (300) into coherent segments (257) where each coherent segment has a meaningful function within the web page (300);
calculating, with the web page analysis device (105), a block importance score for each segment (257);
detecting, with the web page analysis device (105), an approximate main area of the web page (300) by analyzing DOM sub-trees (209) to produce a conservative determination of which sub-trees (209) in the web page (300) should be discarded to produce a stripped-down web page;
scoring, with the web page analysis device (105), sub-trees (209) contained within the approximate main area of the web page using a best sub-tree computation module (345) within the web page analysis device (105); the scoring of sub trees (209) comprising:
computing a sub-tree importance score by identifying all segments (260, 265, 270, 275, 280, 285) which intersect a sub-tree (225) and taking the weighted average of block importance scores of each segment (260, 265, 270, 275, 280, 285) which intersects the sub-tree (225);
computing an area score by determining a desired size of print-worthy content and by penalizing sub-trees which are larger or smaller than the desired size of print-worthy content;
combining the sub-tree importance score and area score to produce a final core;
selecting a single sub-tree (225) with the highest final score as the main content (350) of the webpage (300); and
outputting the main content (350) to a printer (145) for printing.

13. A web page analysis device (105) for selection of the main content (350) of a web page (300) comprising:
a plurality of modules (305, 330, 335) which make up a print-worthy content selection algorithm (302);
a memory (130) for storing the print-worthy content selection algorithm (302);
a processing unit (125) for accepting the print-worthy content selection algorithm (302) from the memory (130) and executing the modules (305, 330, 335) of the print-worthy content selection algorithm (302); and
a network adapter (140) for receiving a web page (300) from a web page server (115);
in which the plurality of modules (305, 330, 335) comprises:
an approximate main area detection module (340) for elimination of DOM sub-trees (209) which do not contain main content (350) of the web page (300), the elimination of DOM sub-trees (209) producing a stripped-down web page; and
a best sub-tree computation module (345) for accepting the stripped-down web page and determining which one of remaining sub-trees (209) contains the main content (350) of the web page (300).

14. The device according to claim 13, further comprising:
a web page segmentation module (305) for segmenting the web page (300) into coherent segments (257) where each coherent segment has a meaningful function in the web page (300); and
a block importance module (330) for calculating block importance for each coherent segment (257).

15. The device according to claim 14, further comprising a browser for parsing and rendering the web page to generate the DOM tree (200) with the associated visual information, in which the web page segmentation module (305) accepts and processes the DOM tree (200) and associated visual information.
